(19) United States
(12) Patent Application Publication
(10) Pub. No.: US 2007/0200488 A1
(43) Pub. Date: Aug. 30, 2007

(54) DISPLAY DEVICE

(76) Inventor: Naoyuki ITO, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/678,726

(22) Filed: Feb. 26, 2007

(30) Foreign Application Priority Data
Feb. 27, 2006 (JP) 2006-050624

(51) Int. Cl. H05B 33/00

(52) U.S. Cl. 313/500; 313/503; 313/505

(57) ABSTRACT

The present invention provides an organic light emitting display device which suppresses occurrence of color mixing without lowering light use efficiency.

The organic light emitting display device has a plurality of light emitting devices each disposed in a region surrounded with a lattice (cross)-like bank, and stripe-shaped pixels of an identical color are arranged side by side and displayed due to the emission of the light emitting devices. In the light emitting device, the height of the bank between identical color pixels is formed lower than the height of the bank between different color pixels, thereby suppressing wet spread between adjacent different color pixels to each other upon formation of identical color pixel formation.

### CLAIM OF PRIORITY

The present application claims priority from Japanese Application JP 2006-050624 filed on Feb. 27, 2006, the content of which is hereby incorporated by reference into this application.

### BACKGROUND OF THE INVENTION

1. Field of the Invention

The present invention relates to a display device having plural light emitting elements in which a light emitting layer is disposed between a pair of electrodes to emit light by application of an electric field to the light emitting layer by the pair of electrodes. In particular, the invention relates to a structure of a bank for suppressing generation of color mixture caused by the bank as a non-light emission portion of the light emitting element.

2. Description of the Related Art

In recent years, as a flat panel type display device, liquid crystal display devices (LCD), plasma display devices (PDP), electron emission type display devices (FED), organic light emitting devices (OLED), etc. have been put to practical use or in the course of study for practical use. Among them, the organic light emitting device is an extremely prospective display device in the feature as a typical self emitting type display device of reduced size and weight. The organic light emitting device includes, so-called bottom emission type and top emission type devices.

The bottom emission type organic light emitting display device has an organic light emitting element with a light emission mechanism of successively stacking, on a light permeable substrate preferably made of a glass substrate, a light permeable electrode as a first electrode or one of electrodes, an organic light emitting layer that emits light by the application of an electric field (also referred to as an organic multi-layered film), and a reflective metal electrode as a second electrode or the other electrode. Such organic light emitting elements are arranged in plurality in a matrix form and they are sealed by an insulating substrate (also referred to as a sealing casing) covering the stacked structure to seal the light emission structure from the external atmosphere.

For example, the light permeable electrode is used as a positive electrode and a reflective metal electrode is used as a negative electrode. An electric field is applied between both of the electrodes. Carriers (electrons and holes) are injected into the organic light emitting layer. The organic light emitting layer emits light. The emitted light is adapted to emit from the side of the light permeable substrate to the outside.

On the other hand, the top emission type organic light emitting display device has a structure of forming the one electrode described above with a reflective metal electrode and the other electrode with a light permeable electrode. An electric field is applied between both of the electrodes to emit light from the organic light emitting layer. The emitted light is output from the side of the electrode (light permeable electrode). In the top emission type, a light permeable substrate is used as the sealing casing in the bottom emission type.

In the organic light emitting device of this type, organic materials emitting light of three primary colors of red, green, and blue have been arranged in a matrix form, in a multi-color display organic light emitting display device having a plurality of organic light emitting devices forming different colors respectively. Since it is necessary to arrange the organic materials for the three primary colors in the matrix form at a high accuracy, complicate light exposure process, etching process, etc. have been essential. Then, to arrange the organic materials for the three primary colors conveniently, it has been adopted means of previously forming a bank and patterning the organic materials by utilizing the bank.

As the structure of the bank partitioning the organic materials for the three primary colors, JP-A No. 2003-229256 (Patent Document 1) discloses a bank formed in a lattice shape and with longitudinal and lateral thicknesses which are the same. Further, as another bank structure, JP-A No. 2005-71656 (Patent Document 2) describes that a bank is not formed into a lattice shape but formed into a stripe shape.

However, in the organic EL device disclosed in the Patent Document 1, since the thickness is identical between the longitudinal and the lateral portions of the lattice-like bank in the structure, if an organic material of an amount exceeding the height of the bank is supplied to a region surrounded with the banks, the organic material exceeds the banks prevailing to adjacent pixel regions. When such a state occurs in the case of a light emitting layer where organic materials emit light of different colors, the electric characteristics or light emission spectrum are changed. Further, in the case of forming a CF (Color Filter) layer or a CCM (Color Conversion System) layer in a region surrounded with banks, there has been a problem that the emission spectrum changes.

Further, in the organic EL display disclosed in the Patent Document 2, the bank is not provided in a lattice shape but formed in the stripe shape. The bank requires a great amount of the organic material compared with the case of forming the bank in the lattice shape. Also, a leak current occurs at the longitudinal end of a pixel electrode, resulting in reduction in the emission efficiency. Further, since the light emitted in the organic light emitting layer does not go to the screen, it results in a problem that the efficiency of utilizing light may be lowered.

Accordingly, the present invention has been accomplished for overcoming the existent problems described above and intends to provide an organic light emitting display device capable of suppressing occurrence of color mixing without lowering the light utilization efficiency.

### SUMMARY OF THE INVENTION

To attain the foregoing object, in a display device according to the invention having plural light emitting devices disposed in regions each surrounded with a lattice (cross)-like bank in which stripe-shaped pixels of an identical color due to light emission of the light emitting devices are arranged adjacent to each other, since the bank between pixels of an identical color is formed with a height lower than that of the bank between pixels of different colors, wet spread to pixels having different colors adjacent to each other can be suppressed upon forming pixels of an identical color and accordingly, the problem in the related art can be solved.

It will be apparent that the invention is not restricted to each of the constitutions described above and the constitutions to be described in the subsequent embodiments but can be modified variously without departing the technical idea of the invention.

According to the display device of the invention, since pixel materials for different colors less prevail to the adjacent pixel formation regions by making the height of the bank adjacent to pixels of an identical color to lower than that for the banks adjacent to pixels of different colors, it has an extremely excellent effect capable of suppressing the occurrence of color mixing, and increasing the resolution power remarkably without lowering the light utilization efficiency, thereby obtaining image display at high display quality.

### BRIEF DESCRIPTION OF THE DRAWINGS

Preferred embodiments of the present invention will be described in details based on the drawings, wherein

FIG. 1 is a view schematically showing the constitution of an organic light emitting display device for explaining Example 1 of a display device according to the invention in which

FIG. 1A is a plan view of a main portion of an organic light emitting display device;

FIG. 1B is a cross sectional view taken along line A-A of FIG. 1A; and

FIG. 1C is a cross sectional view taken along line B-B of FIG. 1A;

FIG. 2 is a perspective view of FIG. 1;

FIG. 3 is a cross sectional view of a main portion of a thin film transistor and a scanning wiring portion taken along direction X of FIG. 1A;

FIG. 4 is a cross sectional view of a main portion of a data line and a bank portion taken along direction X of FIG. 1A;

FIG. 5 is a cross sectional view of a main portion of a thin film transistor, scanning wirings, and a lower bank portion taken along direction Y of FIG. 1A;

FIG. 6 is perspective view of a main portion showing the state after coating an organic material solution in the bank;

FIG. 7 is an enlarged perspective view of a main portion showing the state after coating an organic material solution in the bank;

FIG. 8 is a perspective of a main portion showing the state after coating and drying an organic material solution in a bank; and

FIG. 9 is an explanatory view of an example of the entire constitution of an organic light emitting display device.

### DETAILED DESCRIPTION OF THE PREFERRED EMBODIMENTS

Preferred embodiments of the invention are to be described specifically with reference to the drawings for examples. In the examples to be described later, a description is made taking a bottom emission type organic light emitting display device as an example. Further, while the organic light emitting device includes low molecular weight material type and high molecular weight material type as the organic material used for portions contributing to light emission, the invention is not restricted to them but it may be formed of an organic light emitting layer by mixing both of the low molecular weight material type and the high molecular weight material type.

The organic light emitting device of the low molecular weight material type are generally formed of an anode electrode, a hole injection layer, a hole transport layer, a light emitting layer, an electron transport layer, and a cathode electrode in this order from the side of the light permeable main substrate. On the other hand, the high molecular weight material type organic light emitting device are generally formed of an anode electrode, a hole transportation layer, a light emitting layer, and a cathode electrode in this order from the side of the light permeable main substrate. In the case of the high molecular weight material type organic light emitting device, the hole transport layer may sometimes have characteristics for both of the hole injection layer and hole transport layer of the low molecular weight type material type organic light emitting device. Further, in the high molecular weight material type organic light emitting device, the electron transport layer and cathode electrode of the low molecular weight material type organic light emitting device is sometimes replaced only with the cathode electrode. Further, the invention is not restricted only to the materials and the compositions used in the subsequent examples.

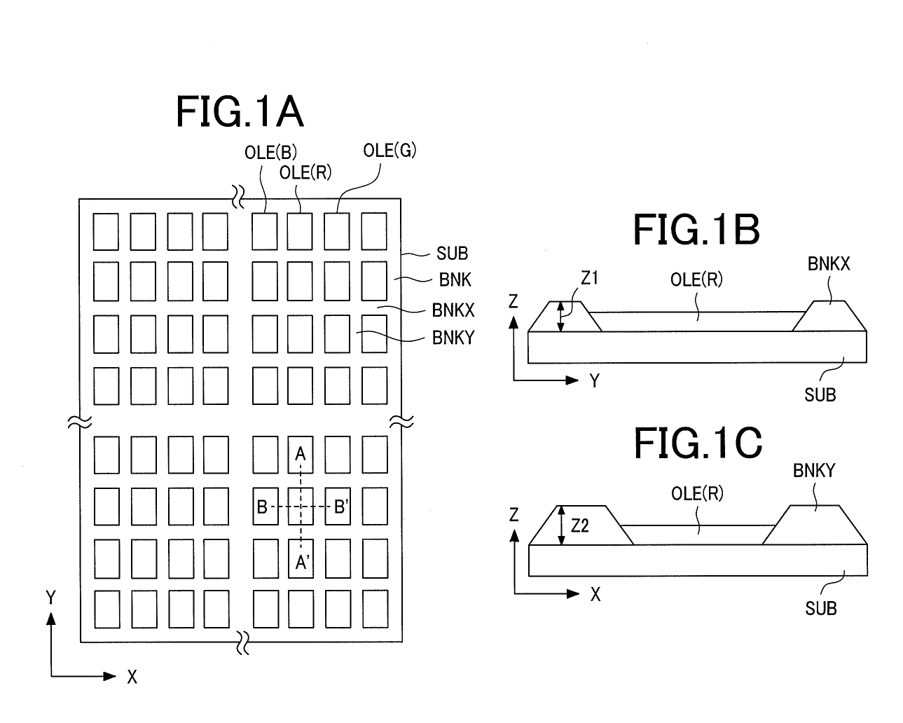

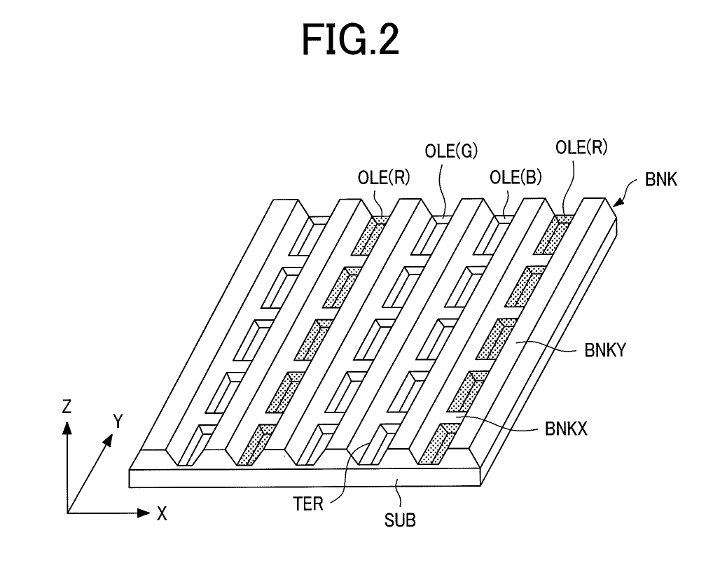

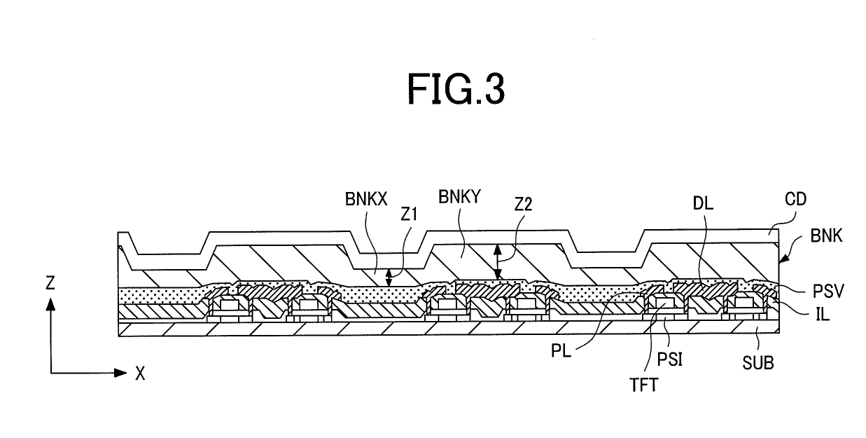

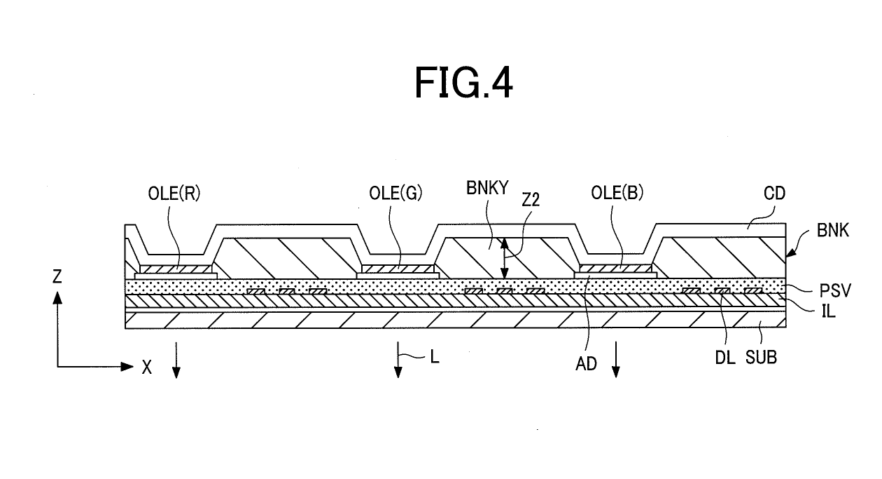

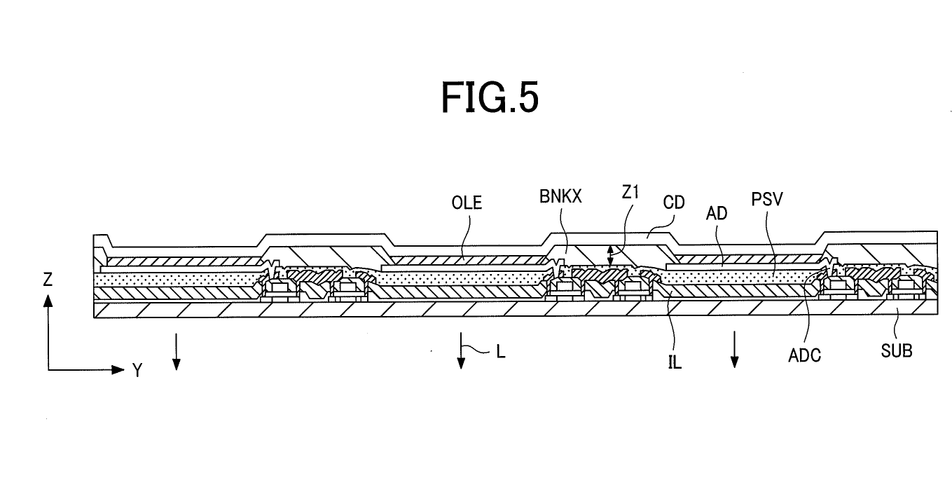

FIG. 1 is a view showing an example of an entire constitution for explaining Example 1 of an organic light emitting display device according to the invention. FIG. 1A is a plan view of a main portion; FIG. 1B is a cross sectional view taken along line A-A of FIG. 1A; and FIG. 1C is a cross sectional view taken along line B-B of FIG. 1A. FIG. 2 is a perspective view of FIG. 1. Further, FIG. 3 is a cross sectional view of a main portion of a thin film transistor and a scanning wiring portion taken along direction X of FIG. 1A; FIG. 4 is a cross sectional view of a main portion of a data line and a bank portion taken along direction X of FIG. 1A; and FIG. 5 is a cross sectional view of a main portion of a thin film transistor, scanning wirings, and lower bank taken along direction Y of FIG. 1A.

In the drawings, the organic light emitting display device is an active matrix type as shown in FIG. 3 to FIG. 5, and is a so-called bottom emission type display device of emitting a display light from the side of a light permeable main substrate SUB.

In the organic emission display device, as shown in FIG. 1 and FIG. 2, a red organic light emitting layer OLE (R), a green organic light emitting layer OLE (G), and a blue organic light emitting layer OLE (B) are arranged side by side in a stripe shape each in a concave portion surrounded with a bank BNK formed in a lattice (cross)-like shape to the main surface (inner surface) of a light permeable main substrate SUB preferably formed of light permeable glass.

The organic light emitting display device, as shown in FIG. 3 to FIG. 5, has a thin film transistor TET as an active device to the main surface (inner surface) of a permeable main substrate SUB preferably formed of light permeable glass, and a red organic light emitting layer OLE (R), a green organic light emitting layer OLE (G), and a blue organic light emitting layer OLE (B) are put between one electrode (anode in this case) and the other electrode (cathode in this case) driven by the thin film transistor TFT to constitute an organic light emitting device.

Further, the thin film transistor TFT is connected to each of the red organic light emitting layer OLE (R), the green organic light emitting layer OLE (G), and the blue organic light emitting layer OLE (B) to constitute a pixel circuit. The thin film transistor TFT is constituted with a polysilicon semiconductor layer PSI, a power source wiring PL, a data signal wiring DL, and scanning signal wirings (not illustrated) and formed each by way of a plurality of inter-layer insulating layers.

Then, the pixel circuit including the thin film transistor TFT is disposed to the red organic light emitting layer OLE (R), the green organic light emitting layer OLE (G), and the blue organic light emitting layer OLE (B) to the surface of the light permeable substrate SUB, the pixel circuit being hidden in the lower layer of the bank BNK.

Further, the anode AD as the pixel electrode is formed of a transparent conductive thin film such as of ITO (In—Ti—O) or IZO (In2O3-ZnO) formed in the upper layer of the passivation layer PAS, and electrically connected to the power source wiring PL by way of an anode contact ADC formed in a contact hole perforated in the passivation layer PAS and the inter-layer insulating layer. Further, the organic light emitting layer OLE is formed in a concave portion surrounded with the bank BNK formed to the insulating layer such as, for example, of acrylic resin or SiN coated on the anode AD by coating means such as an ink jet method or a vapor deposition method.

While the details are to be described later, the bank BNK has a structure formed into a lattice (cross)-like shape and formed such that the height of the bank BNK between pixels emitting an identical color (hereinafter referred to as an identical color pixel) is lower than the height of the bank between pixels emitting light of different colors (hereinafter referred to as different color pixel).

The bank BNK is utilized for the region restriction in the process for forming the organic layer for each of the organic light emitting layers OLE, particularly, in the process for forming the light emitting layer thereof. The region for the bank BNK is not utilized for display. Further, the thin film transistor TFT, etc. constituting the pixel circuit is formed to a portion hidden by the bank BNK. Then, a cathode CD is formed of a conductive solid film such as a thin aluminum film or thin chromium film while covering the organic light emitting layer OLE and the bank BNK.

The organic EL display device is a so-called bottom emission type and emission light from the organic light emitting layer OLE is emitted from the outer face (surface) of the main substrate SUB to the outside in the direction shown by arrows. Accordingly, a conductive thin film having a light reflecting performance is used for the cathode CD. While not illustrated, a sealing glass substrate also referred to as a seal casing is opposed to the main surface of the main substrate SUB and is airtightly sealed with a sealing member attached to the periphery thereof to maintain the inside in a vacuum state.

The bank BNK, as shown in FIG. 1B and FIG. 1C, is formed into a lattice (cross)-like shape in which it protrudes in the direction Z from the plane X-Y by way of a light permeable inter-layer insulating film (not illustrated) above the main substrate SUB, and the height in the direction Z of the bank BNKX formed along the direction X is lower than that of the bank BNKY formed along the direction Y. Each of concave regions surrounded with the lattice formed by the bank BNKX and the bank BNKY constitutes a pixel formation region TER.

The bank BNK has a structure with banks BNKX and banks BNKY formed in an integrated manner with a relation of Z2>Z1, where Z1 is a height in the direction Z of the bank BNKX formed along the direction X as shown in FIG. 1B; and Z2 is a height in the direction Z of the bank BNKY formed along the direction Y as shown in FIG. 1C. That is, it is formed such that the height Z2 of the bank BNKY formed along the direction Y is larger than the height Z1 in the direction Z of the bank BNKX along the direction X.

Further, in each of the pixel formation regions TER surrounded with the banks BNKX along the direction X and the banks BNKY along the direction Y, each of the pixel formation regions TER arranged along the direction X constitutes the arrangement of the different color pixels, while each of the pixel formation regions TER arranged along the direction Y constitute the arrangement of identical color pixels as shown in FIG. 2.

For a method of forming the bank BNK having different heights between the direction X and the direction Y, it can be formed easily by 1-photolithographic process with half-exposure to the height of a certain bank, or by a 2-photolithogaphic process of forming banks of an identical height and adding high banks. Further, for the material forming the bank BNK, organic materials, for example, acrylic resin, polyimide resin, or novolac resin, or inorganic materials such as SiN or SiO can be used.

In a case of forming the bank BNK with the organic material, to provide the bank BNK with an ink repelling property, an SF6 plasma treatment is, for example, applied to make the surface water repellent. Alternatively, a high molecular or low molecular weight organic material as an organic material forming the organic light emitting layer in a pixel formation region TER is dissolved in a solvent capable of dissolving the same respectively to form a homogeneous solution, and dipped so as to form a predetermined film thickness, for example, by an ink jet method and then dried. After forming the organic light emitting layer, the electrode is formed and sealed.

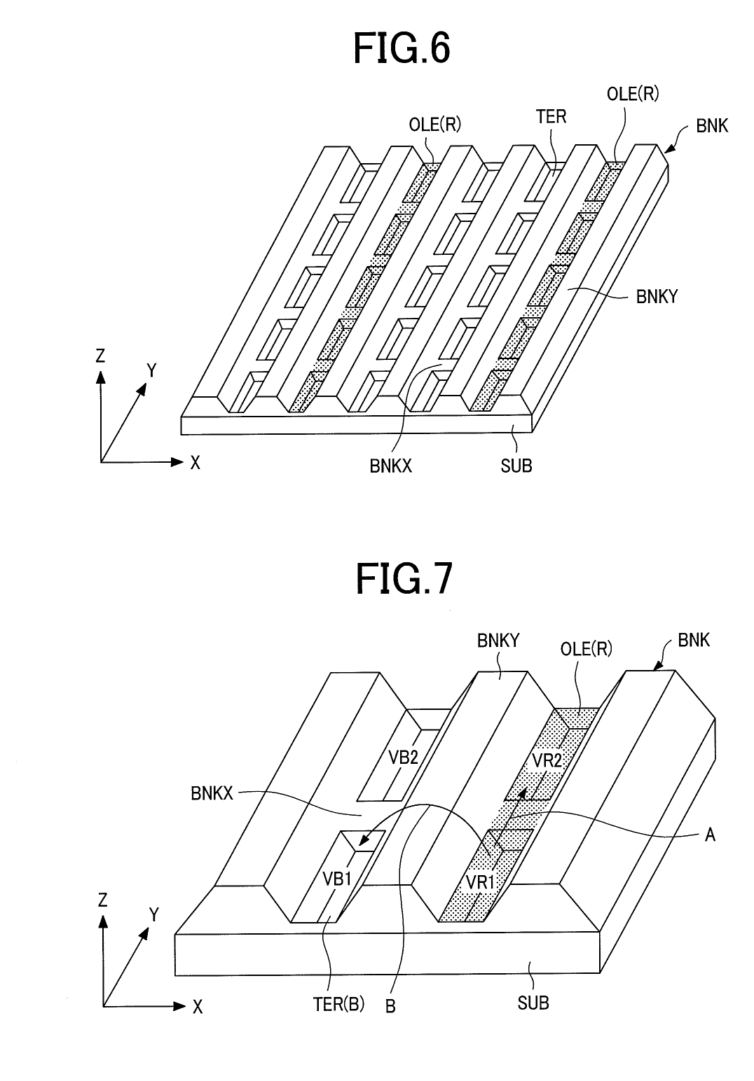

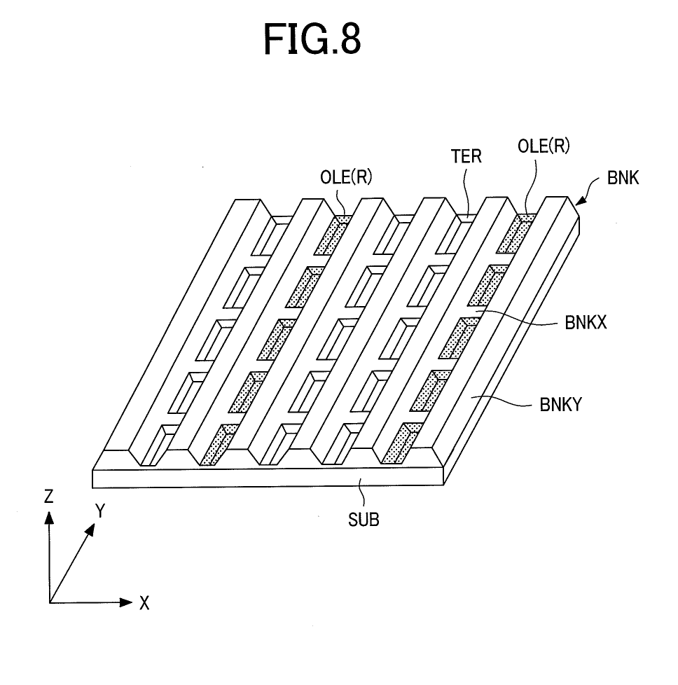

In the bank BNK constructed as described above, the bank BNKY formed along the direction Y is formed with the height Z2 higher than the height Z1 for the bank BNKX formed along the direction X. When a solution of an organic material that emits light of an identical color, for example, an organic material solution OLER that emits a red color is dripped and coated in a linear shape along the direction of an arrow A in the pixel formation region TER arranged along the bank BNKY in the direction Y as shown in the perspective view of FIG. 6 at a solution concentration corresponding to the inner volume VR1=VR2= . . . VRn of the pixel formation region TER, and then the organic material solution OLER is dried, the organic material solution OLER on the bank BNKX formed along the direction X is repelled by the repelling action to form a homogeneous red emitting organic light emitting layer OLE (R) in each of the pixel formation regions TER along the direction Y as shown in the perspective view of FIG. 8.

Further, as shown in FIG. 7, after dripping and coating a blue emitting organic material solution by an amount of solution at a solution concentration corresponding to the inner volume VB1=VB2= . . . VBn to the blue pixel formation region TERB which is adjacent by way of the bank BNK to the red emitting organic light emitting layer OLE (R), when the blue emitting organic material solution is dried, the blue emitting organic material solution on the bank BNKX along the direction X is repelled by the repelling action and a homogeneous blue emitting organic light emitting layer can be formed in each of the pixel formation regions TERB along the direction Y.

That is, in this example, the height of the bank BNKX adjacent to pixels of an identical color is made lower than the height of the bank BNKY adjacent to the different color pixels. In this case, the height of the bank is not made uniform, and the height of the bank adjacent to the identical color pixel is not reduced to 0 but it is made lower than the height of the bank adjacent to the different color pixel and made higher than 0. Specifically, occurrence of color mixing is suppressed by the combination of the high bank in which wet spread of the coated organic material solution does not occur to the different color pixel and a lower bank having such an extent of thickness that wet spread of the coated organic material solution may occur but does not cause leak current at the end of the pixels.

Accordingly, since the height of the bank BNKY formed along the direction Y is made higher than that of the bank BNKY formed along the direction X, as shown in FIG. 7, wet spread of the red emission organic material solution OLER can be prevented while overriding the bank BNKY formed along the direction Y to the adjacent different color pixel formation region, for example, the blue pixel formation region TERB in the direction shown by an arrow B. Accordingly, the different color light emitting organic layers do not cause color mixing. Further, this is same as the case of adjacent organic material solutions emitting different colors.

At present, in the ink jet methods of preparing a high molecular weight organic light emitting layer, although a predetermined amount of an organic material solution is dripped into the bank, this causes problems such as fluctuation of the solution injection amount or the solution dripping position, and mixing of ink colors. Thus, it can not be said to be an easy process. Further, along with increase in the resolution power of the display device, a more difficult process is obliged regarding the problems described above. On the contrary, in this example, since the height Z1 of the bank BNKX between identical color pixels is formed lower than the height Z2 of the bank BNKY between different color pixels, the film can be formed by dripping an organic material solution SOL at an identical concentration between the banks BNKY formed along the direction Y and coating (injecting) a solution in an amount corresponding to the inner volume of the bank, so that a homogeneous organic light emitting layer can be formed by a simple and easy process. Further, increase of the resolution power can be attained easily by an easy process.

Then, a description is made of a method of forming an organic light emitting layer in the pixel formation region TER in the constitution of Example 1. At first, PEDT (polyethylene dioxythiophene)/PSS (polystyrene sulfonic acid) was formed with a thickness of about 40 nm as a hole injection layer on the anode which is a pixel electrode of the light permeable main substrate SUB formed with thin film transistors TFT. After that, a blue light emitting layer was formed of F8 (polydioctyl fluorine) with a thickness of about 45 nm. The green light emitting layer was formed of PPV (polyphenylene vinylene) with a thickness of about 30 nm and of F8 with a thickness of about 45 nm, each of which was stacked.

Further, a red light emitting layer was formed by stacking R-PPV with a thickness of about 40 nm and F8 with a thickness of about 45 nm. Then, LiF (lithium fluoride) was formed with a thickness of about 2 nm. Further, as the cathode material, Ca (calcium) and Al (aluminum) were stacked with a thickness of about 100 nm and 200 nm, respectively. Finally, SiN (silicon nitride) was formed with a thickness of about 50 nm being stacked by three layers. When a DC voltage of about 6 V was applied between the anode and the cathode of the thus formed organic light emitting device, a white light emission at a brightness of about 800 dc/m2 or more could be obtained.

Further, for the constitution of Example 1, another method of forming the organic light emitting layer in the pixel formation region TER is to be described. At first, PEDT (polyethylene dioxythiophene)/PSS (polystyrene sulfonic acid) was formed with a thickness of about 40 nm as a hole injection layer on an anode as the pixel electrode of the light permeable main substrate SUB1 formed with a thin film transistor TFT. After that, a blue light emitting layer was formed of F8 (polydioctyl fluorine) with a thickness of about 45 nm. A green light emitting layer was formed of PPV (polyphenylene vinylene) with a thickness of about 30 nm and of F8 with a thickness of about 45 nm by stacking as light emitting layers for respective colors.

Further, a red light emitting layer was formed by stacking R-PPV with a thickness of about 40 nm and F8 with a thickness of about 45 nm. Then, LiF was formed with a thickness of about 2 nm. As the cathode material, Ca/Al was formed by stacking to have about 5 nm thickness. Finally, SiN was stacked in three layers to have about 50 nm thickness. When a DC voltage of about 6 V was applied between the anode and the cathode of the thus formed organic light emitting device, a white light emission of a brightness of about 800 CD/m2 or more could be obtained.

Further, in the constitution of Example 1 described above, a further method of forming the organic light emitting layer in the pixel formation region TER is to be explained. At first, on the anode as the pixel electrode of the light permeable main substrate SUBI formed with the thin film transistor TFT, MTDATA (4,4′,4″tris[-N-(−3-methylphenyl)-N-phenylamide]triphenylamine) with about 70 nm thickness, α-NPD with about 10 nm thickness, a distylyl benzene derivative (DTVBi)/perylene with about 60 nm thickness (5%), and tris(8-hydroxyquinolino)aluminum (Alq) with about 60 nm thickness were successively stacked as the hole injection layer.

Then, a green light emitting layer was formed by stacking MTDATA with about 70 nm thickness, α-NPD with about 10 nm thickness, Alq/quinacridone with about 60 nm thickness (5%), and Alq with about 60 nm thickness respectively. Further, a red light emitting layer was formed by stacking MTDATA with about 70 nm thickness, α-NPD with about 10 nm thickness, Alq/DCM2 with about 60 nm (2%) thickness, and Alq with about 60 nm thickness were formed successively. Finally, Al was formed with about 70 nm thickness as the cathode material, and SiN (silicon nitride) with about 50 nm was formed in three layers by stacking. When a DC voltage of about 6 V was applied between the anode and the cathode of the thus formed organic light emitting device, a white light emission of a brightness of about 800 dc/m2 or more could be obtained.

Then, in the constitution of Example 1 described above, another method of forming the organic light emitting layer in the pixel formation region TER is to be explained. At first, on the anode as the pixel electrode of the light permeable main substrate SUBI formed with the thin film transistor TFT, MTDATA with about 70 nm thickness, α-NPD with about 10 nm thickness, a distylyl benzene derivative (DTVBi)/perylene with about 60 nm thickness (5%), and tris(8-hydroxyquinolino) aluminum (Alq) with about 60 nm thickness were successively formed as the hole injection layer.

Then, a green light emitting layer was formed by stacking MTDATA with about 70 nm thickness, α-NPD with about 10 nm thickness, Alq/quinacridone with about 60 nm thickness (5%), and Alq with about 60 nm thickness respectively. Further, a red light emitting layer was formed by stacking MTDATA with about 70 nm thickness, α-NPD with about 10 nm thickness, Alq/DCM2 with about 60 nm (2%) thickness, and Alq with about 60 nm thickness were formed successively. Finally, LiF with about 0.5 nm and Mg/Ag with about 5 nm were formed as the cathode material, and SiN (silicon nitride) with about 50 nm was formed in three layers by stacking. When a DC voltage of about 6 V was applied between the anode and the cathode of the thus formed organic light emitting device, a white light emission of a brightness of about 800 dc/m2 or more could be obtained.

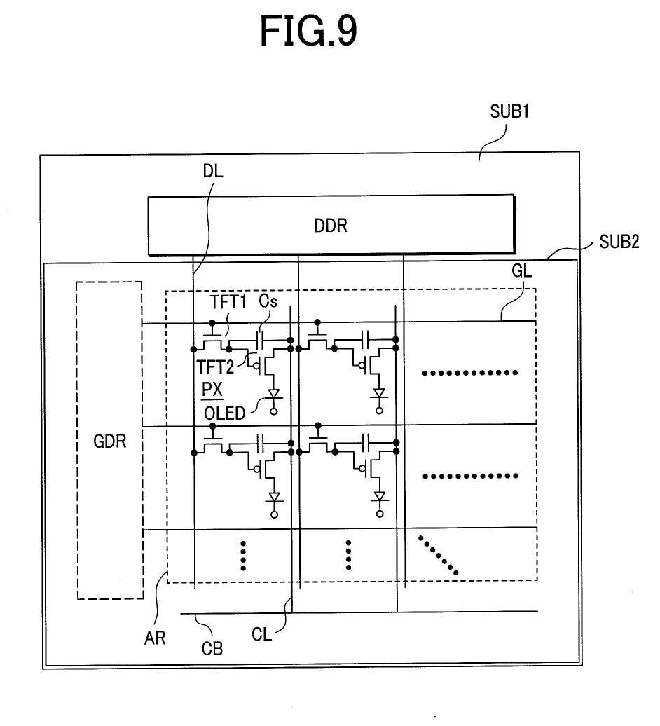

FIG. 9 is an explanatory view for the example of an entire constitution of an organic light emission display device. Pixels (PX) having the constitution as has been explained in FIG. 1 are arranged in a matrix to constitute a 2-dimensional organic light emission display device. Each pixel (PX) comprises a first thin film transistor TFT1, a second thin film transistor TFT2, a capacitor Cs, and an organic light emitting device OLED. The organic light emitting device OLED constitutes a pixel of the structure described in FIG. 1. In a display region AR, drain lines DL and gate lines GL are arranged crossing with each other for supplying driving signals to each of the pixels. A main substrate SUB1 has a larger size than the sealing glass substrate SUB2. A part of the main substrate SUB1 protrudes out of the sealing glass substrate SUB2. A drain driver DDR is mounted on the protruded portion to supply display signals to drain lines DL.

On the other hand, a gate driver GDR is formed directly on part of the main substrate SUB1 which is covered with the sealing glass substrate SUB2 in a so-called system-on-glass form. The gate lines GL are connected with the gate driver GDR. Power source lines CL are disposed in the display region AR. The power source lines CL are connected to an external power source by way of a power source bus line with terminals (not illustrated).

The gate lines GL are connected to either one of the source electrodes or drain electrodes (gate electrodes in this case) of the first thin film transistors TFT1 constituting the pixels PX. The drain lines DL are connected to either one of the source electrodes or drain electrodes (source electrodes in this case). The first thin film transistor TFT1 is a switch for acquiring display signals to the pixel PX and stores, into a capacitor CS, charges corresponding to the display signal supplied from the drain line DL when it is selected and turned-on by the gate line GL. The second thin film transistor TFT2 is turned on when the first thin film transistor TFT1 turns off. Then, the second thin film transistor TFT2 supplies a current in accordance with the magnitude of display signals accumulated in the capacitor Cs from the power source line CL to the organic light emitting device OLED. The organic light emitting device OLED emits light in accordance with the amount of current supplied.

In the examples described above, while description has been made of the bottom emission type organic light emission display device, it will be apparent that the invention is not restricted only to the bottom emission type organic light emission display device, similar effects to those of each of the examples described above can be obtained when the top emission type organic light emission display device is applied.

Further, in the examples described previously, while the description has been made of the organic light emitting device mounting the organic light emitting device as the display device, it will be apparent that the invention is not restricted to them but is generally applicable to organic light emitting devices included in a TV, PC monitor, notebook PC, PDA, mobile telephone, digital still camera, digital video camera, car navigation monitor, etc.

What is claimed is:

1. A display device having a plurality of light emitting devices on a main surface of a light permeable substrate that is opposed to an insulating substrate and that is airtightly sealed with a sealing member attached to a peripheral portion of the main surface of the light permeable substrate, each of the light emitting devices including a plurality of first electrodes formed on the main surface of the light permeable substrate, a light emitting layer formed covering the plurality of the first electrodes and having a light emitting ability, and a second electrode formed in common with the plurality of light emitting devices on the light emitting layer, the plurality of the light emitting devices forming pixels partitioned from each other by banks, and emitting light from the light emitting layer by way of the first electrode on the side of the light permeable substrate, wherein
stripe-shaped pixels of an identical color due to the emission of the light emitting layer are arranged side by side, and the height of the banks between the pixels of an identical color is lower than the height of the banks between the pixels of different colors.

2. The display device according to claim 1, wherein the bank is formed of an organic material.

3. The display device according to claim 2, wherein the organic material comprises a low molecular weight material.

4. The display device according to claim 2, wherein the organic material comprises a high molecular weight material.

5. The display device according to claim 1, wherein the bank is formed of an inorganic material.

6. The display device according to claim 1, wherein the bank is formed of a laminate of an organic material and an inorganic material.

7. The display device according to claim 1, wherein the light emitting layer is an organic light emitting layer formed by an ink jet method.

8. The display device according to claim 1, wherein the light emitting layer is an inorganic light emitting layer formed by a vapor deposition method.
